(19) United States
(12) Patent Application Publication
(10) Pub. No.: US 2008/0171230 A1
(43) Pub. Date: Jul. 17, 2008

(54) Thin Film Ferroelectric Composites, Method of Making and Capacitor Comprising the Same

(76) Inventors: Qin Zou, Toronto (CA); Gerhard Hirmer, Aurora (CA); George Xing, Markham (CA)

Correspondence Address: JONES & SMITH, LLP, 2777 ALLEN PARKWAY, SUITE 800, HOUSTON, TX, 77019-2141, US

(21) Appl. No.: 10/590,918

(22) PCT Filed: Feb. 25, 2005
(86) PCT No.: PCT/IB05/00477

§ 371 Date: Oct. 9, 2007

Related U.S. Application Data
(60) Provisional application No. 60/548,536, filed on Feb. 27, 2004.

(51) Int. Cl. B05D 5/12

(52) U.S. Cl. 428/704; 427/100

(57) ABSTRACT

Thin film ferroelectric capacitor composites exhibiting reduced leakage current and enhanced breakdown strength are prepared using sol-gel processing. The composite contains a buffer layer and at least one dielectric layer and is formed by depositing by sol-gel processing onto a substrate a composition containing a heterocyclic amide, such as polyvinylpyrrolidone.

### FIELD OF THE INVENTION

The present invention relates to crystalline ferroelectric thin films useful in thin film capacitors, ferroelectric memory devices, pyroelectric sensor devices, wave guide modulators, and acoustic sensors which exhibit improved electrical characteristics, such as reduced leakage current and enhanced breakdown strength and to a method of preparing such ferroelectric films.

### BACKGROUND OF THE INVENTION

Sol-gel coating is a technique for depositing thin films at relatively low temperatures. Such techniques, which may be used to produce piezoelectric thin films, minimize thermal expansion from a mismatch between a dielectric coating and substrate. In piezoelectric thin films, it is not uncommon for cracks to result in the composite when sol-gel processing is used. Attempts have been reported in the literature relating to the formation of crack-free piezoelectric thin film composites using sol-gel techniques. For instance, the formation of barium titanate and lead zirconate titanate films fabricated from solutions containing polyvinyl pyrrolidone for the deposition of crack-free thick films has been reported in the literature. See, for instance, Kozuka, H., and Kajimura, M., “Single-Step Dip Coating of Crack-Free BaTiO₃ Films >1 Micro Meter Thick: Effect of Poly(vinylpyrrolidone) on Critical Thickness”, Journal of the American Ceramic Society, vol. 83 (5), pp. 1056-1062, 2000; Kozuka, H., Takenaka, S., Tokita, H., Hirano, T., Higashi, Y., Hamatani, T., “Stress and Cracks in Gel-Derived Ceramic Coatings and Thick Film Formation”, Journal of Sol-Gel Science and Technology, vol. 26 (1-3), pp. 681-686, 2003; and Kozuka, H., Higuchi, A., “Single-Layer Submicron-Thick BaTiO₃ Coatings from Poly(vinylpyrrolidone)-Containing Sols: Gel-to-Ceramic Film Conversion, Densification, and Dielectric Properties”, Journal of Materials Research, vol. 16 (11), pp. 3116-3123, 2001. These publications disclose that the incorporation of polyvinyl pyrrolidone in solutions for sol-gel processing providing the critical thickness to reduce both a crack formation during heating and tensile stress in heat-treated piezoelectric barium titanate films. Yu, S., Yao, K., Shannigrahi, S., Hock, F. T. E., “Effects of Poly(ethylene glycol) Additive Molecular Weight on the Microstructure and Properties of Sol-Gel-Derived Lead Zirconate Titanate Thin Films”, Journal of Materials Research, vol. 18 (3), pp. 737-741 2003 disclose a reduction in crack-free films by the incorporation of polyethylene glycol (PEG) additives with different molecular weights in sol-gel precursor solutions of lead zirconate titanate thin films.

The procedures of the prior art, while reporting the formation of crack-free piezoelectric thick films, are not directed to the production of ferroelectric thin film layer devices, such as capacitors, which exhibit reduced leakage current and uniform electrical and mechanical properties. One of the difficulties in depositing thin ferroelectric films is attributable to the physical properties and quality of the substrate. For instance, the presence of scratches and blemishes on a microscale in the substrate often results in poor uniformity of the deposited films. Further, in light of the flow patterns of the solution during coating, defects are often formed in sol-gel derived films, originating at the surface defects of the substrate. Rough surfaces and associated rough bottom electrodes in capacitor structures result in increased and spatially non-uniform leakage currents generated throughout the capacitor, as well as in its reduced breakdown strength.

Means of developing crack-free ferroelectric films and capacitors which do not exhibit reduced leakage current and which further exhibit uniformity across the capacitor are desired.

### SUMMARY OF THE INVENTION

Multi-layer thin film composites are prepared by depositing onto a substrate, by such sol-gel coating techniques as spin-coating, dip-coating, spray coating, meniscus coating, or flow coating, a composition containing an organic solvent, and organometallic dielectric precursors. A buffer layer, between the substrate and dielectric layer, may further contain a polymeric heterocyclic amide, such as polyvinylpyrrolidone. Upon heating, the buffer layer is formed on the substrate. One or more second dielectric films may then be added by sol-gel techniques followed by heating and annealing.

The multi-layer ferroelectric thin film composite is thus composed of a substrate, a buffer or barrier layer, and at least one dielectric layer. The thickness of the barrier layer is between from about 20 to about 300 nm and the thickness of the second dielectric thin film, either as a single layer or multiple layers, is between from about 50 to about 900 nm. The inorganic oxide of the buffer layer and the dielectric layer may be the same or different.

Exemplary as the inorganic oxide of either the buffer or dielectric layer are lead lanthanide titanate, lead titanate, lead zirconate, lead magnesium niobate, barium titanate, lead zirconate titanate, barium strontium titanate, lanthanum-modified lead zirconate titanate, bismuth zinc niobate and bismuth strontium tantalite. Preferred oxides are lead zirconate titanate, barium strontium titanate, lanthanum-modified lead zirconate titanate, bismuth zinc niobate and bismuth strontium tantalite.

Suitable substrates of the thin film composite include semiconductor, glass and metallic foils, preferably metallic foils.

The presence of the amide groups in the precursor solution, used to sol-gel deposit the buffer layer onto the substrate, promotes structural relaxation, reduces stress evolution during annealing, and results in the formation of a smooth crack-free thin film. In addition, the presence of such amide components assists in the reducing the effect of radiative striations formed during the sol-gel deposition process (typically striations are formed during solvent evaporation following the spreading of sol).

Thin film capacitors, ferroelectric memory devices, pyroelectric sensor devices, wave guide modulators as well as sensors containing the multi-layer thin film composite of the invention exhibit reduced leakage current and uniform capacitance.

### BRIEF DESCRIPTION OF THE DRAWINGS

In order to more fully understand the drawings referred to in the detailed description of the present invention, a brief description of each drawing is presented, in which:

FIG. 1 is a schematic diagram of structure composed of a crystalline dielectric thin film deposited on a metallic foil, according to the present invention.

FIG. 2 illustrates a flow chart diagram illustrating steps of manufacturing a ferroelectric thin film capacitor, according to the present invention.

FIG. 3 presents a scanning electron microscope (SEM) micrograph of a ferroelectric film structure according to the invention.

FIG. 4 is a plot of the leakage current density of a thin film capacitor formed according to the invention.

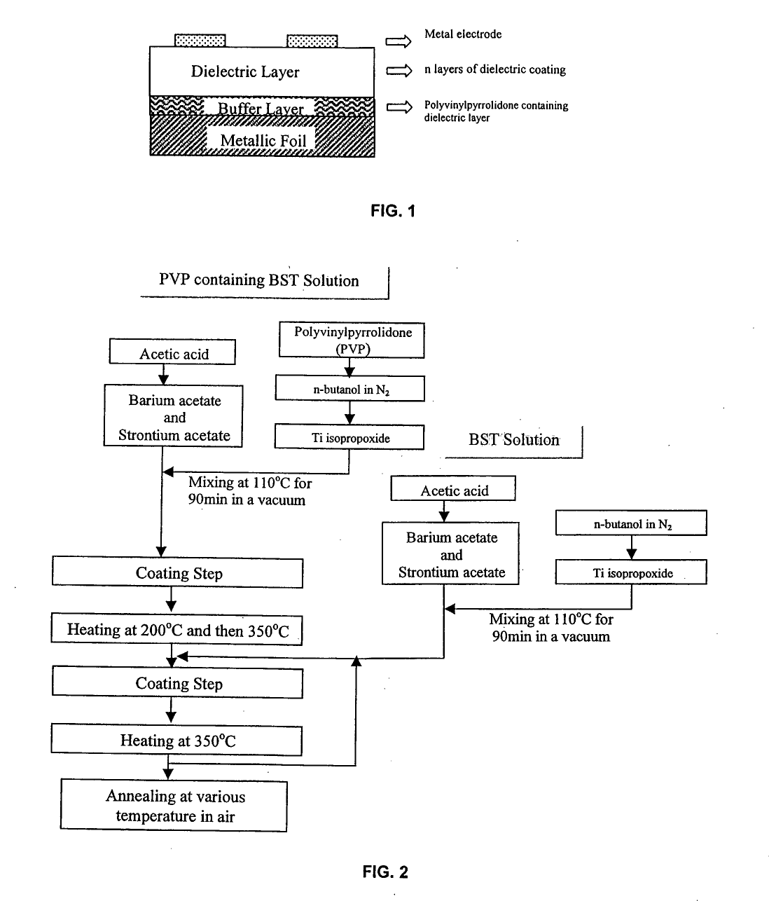

### DETAILED DESCRIPTION OF THE PREFERRED EMBODIMENTS

Sol-gel processing is used to deposit a buffer layer and a dielectric thin film onto a substrate. These structures are suitable in device applications such as thin film capacitors, ferroelectric memory devices, pyroelectric sensor devices, waveguide modulators, and acoustic sensors. Such devices exhibit improved electrical characteristics. For instance, when used in capacitors, use of the ferroelectric thin film composites renders reduced leakage current, enhanced breakdown strength, and improved yield and uniformity across the capacitor.

The thin film ferroelectric structures may be prepared by incorporating a buffer layer between the substrate and the dielectric layer. The dielectric films include polycrystalline as well as nanocrystalline films.

The structure is formed by first depositing onto a substrate a precursor composition for rendering a buffer film layer. The precursor composition contains an organic solvent, polymeric heterocyclic amide and organometallic compounds. Suitable sol-gel techniques for depositing the composition include spin-coating, dip coating, spray coating, meniscus coating, as well as flow coating, PVD (Physical Vapor Deposition), and deposition by MOCVD (Metal Organic Chemical Vapor Deposition). Sol-gel deposition occurs at low temperatures, preferably from about 150° C. to about 225° C. The polymeric heterocyclic amide is preferably polyvinylpyrrolidone.

Heat is then applied and the buffer layer is formed. Typically, the coated substrate is heated to a temperature of from about 100° C. to about 450° C. The heating duration is that sufficient to remove most, if not all, of the organic residue and form a smooth buffer layer onto the substrate. This layer acts as a buffer layer against mechanical stress and mending failures from the metal substrate. The organometallic compounds in the precursor composition form, upon heating, inorganic oxides which, while exhibiting dielectric properties, provide improved attachment and bonding of the dielectric layer onto the substrate. The thickness of the buffer layer is typically in the range between from about 20 to about 300 nm.

A dielectric thin film layer is then deposited onto the buffer layer. Typically, this layer is applied also by sol-gel techniques. Following deposition of this precursor solution, the multi-layered structure is then annealed, typically at a temperature between from about 550° C. to about 750° C. in air.

The dielectric layer may be composed of multiple layers. The thickness of the dielectric film layer, optionally composed of multiple coating layers after heating, is typically between from about 50 to about 900 nm. Further, the thickness of the dielectric layer is usually greater than the thickness of the buffer layer.

Compatibility between the buffer layer and the dielectric layer may be achieved by using some of the same elements, i.e., the inorganic oxides may be composed of some of the same elements, although the ratio of the elements may be different. In a preferred embodiment, the inorganic oxide of the first layer and the dielectric layer are identical.

The dielectric material is preferably selected from the group consisting of a lead lanthanide titanate, lead titanate, lead zirconate, lead magnesium niobate, barium titanate, lead lanthanum zirconate titanate, lead zirconate titanate (PZT), barium strontium titanate, lanthanum-modified lead zirconate titanate, bismuth zinc niobate and bismuth strontium tantalite. In a preferred embodiment, the dielectric thin film material is lead zirconate titanate, barium strontium titanate, lanthanum-modified lead zirconate titanate, bismuth zinc niobate or bismuth strontium tantalite.

Especially preferred as PZT are those titanates of the formula PbZr₁₋ₓ TiₓO₃ (PZT) family with 0<x<1; preferred are those of the formula PbZrₓTiₓO₃ wherein x is between from about 0.30 to about 0.70, more preferably between from about 0.35 to about 0.65. Especially preferred as BST are those titanates of the formula (Ba₁₋ₓSrₓ)TiO₃ wherein 0<x<1.0, most preferably wherein x is between from about 0.1 to about 0.9, most preferably 0.3 to about 0.7. Especially preferred as PLZT are those titanates of the formula Pb_{y}La_{z}(Zr₁₋ₓTiₓ)O₃, wherein x is from about 0.30 to about 0.70, preferably between from about 0.35 to about 0.65, y is from 0.95 to about 1.25, and z is from about 0 to about 0.15. Further preferred as bismuth zinc niobates are those of the formula Bi₃ₓZn₂₍₁₋ₓ₎Nb₂₋ₓO₇ wherein x is from about 0.40 to about 0.75; and bismuth strontium tantalates of the formula SrₓBi_{y}Ta₂O_{5+x+3y/2} wherein x is from about 0.50 to about 1.0 and y is from about 1.9 to about 2.5.

Referring to FIG. 2, the buffer layer is prepared by mixing polyvinylpyrrolidone with an organic solvent and adding to the solution a titanium precursor, such as titanium isopropoxide. Suitable organic solvents include a C₁-C₄ alcohol, like n-butanol, glycol, such as polyethylene glycol and acetic acid. The molar ratio of polyvinylpyrrolidone to titanium metal in the solution is from about 0.1 to about 1.0. The resultant is then introduced to a composition containing organic solvent and the requisite amounts of barium, strontium, lead, lanthanum precursors, such as barium acetate, strontium acetate, lead acetate, lanthanum isopropoxide and polyvinylpyrrolidone. The mixture is stirred at elevated heat, preferably under vacuum. In a preferred embodiment, the mixture is mixed at approximately 110° C. for about 90 minutes.

The resulting solution is then applied by sol-gel deposition techniques, such as spin coating onto a suitable substrate. The substrate may be a semiconductor, a glass, or a metallic foil. Suitable semiconductor substrates include those containing a Group 3-4 or 13-14 element such as silicon, SiGe and GaAs. Suitable metallic foil substrates including aluminum, brass, nickel alloy, nickel-coated copper, platinum, titanium and stainless steel foil. The substrate may further be metal plated, such as platinum plated silicon. The coated substrate is then heated until organic residues are removed. A dense buffer layer forms on the substrate which has a thickness between from about 20 nm to about 300 nm. This layer acts as a buffer layer against mechanical stress and failure from the metal substrate.

A dielectric thin film, prepared substantially as set forth above, is then applied onto the heated composite by sol-gel techniques, such as spin coating. The composite is then heated to remove the organic materials and then annealed. A patterned thin metal layer may be formed. The dielectric thin film may be composed of one or multiple layers. When composed of multiple layers, the dielectric layers may be in a regular or irregular superlattice structure.

The thickness of the dielectric layer is in the range between from about 50 nm to about 900 nm. The thickness of the dielectric thin film is preferably greater than the thickness of the buffer layer.

Ferroelectric thin film capacitors having a patterned thin metal layer and formed by the sol-gel precursor solutions exhibit improved leakage current characteristics and enhanced breakdown strength and defect density due to the presence in the structure of the buffer layer prepared from the precursor composition containing the polymeric heterocyclic amide.

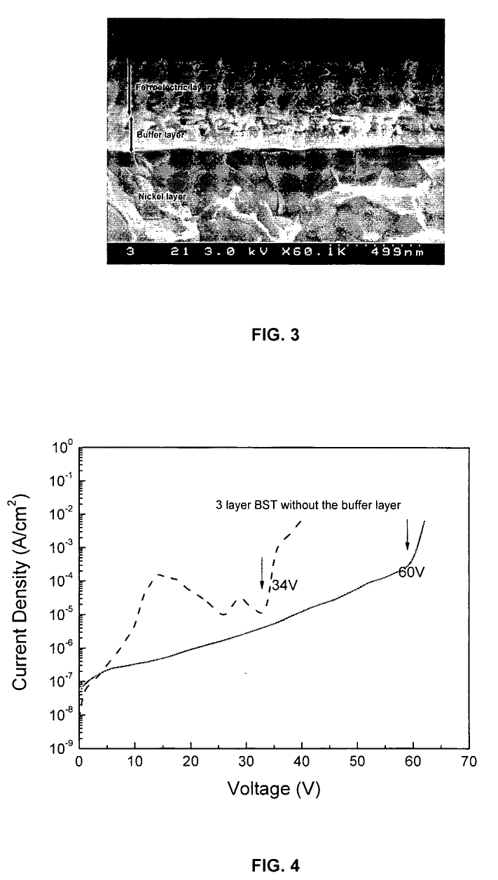

In accordance with the procedures recited above, a ferroelectric film structure containing a BaO_{0.5} SrO_{0.5} TiO₃ dielectric layer was prepared using a nickel-coated copper foil. The buffer layer was prepared by incorporating polyvinylpyrrolidone onto a sol-gel precursor solution. The polyvinylpyrrolidone content was 0.25 mol. The organic metallic compounds in the precursor solution are as set forth in FIG. 2. The resulting buffer layer was a Ba_{0.5}Sr_{0.5}TiO₃ dielectric and had a thickness of about 100 nm. The Ba_{0.5}Sr_{0.5}TiO₃ dielectric layer was prepared as set forth in FIG. 2 and was applied as three layers. The thickness of the three-layered dielectric layer was 450 nm. The film was annealed at 600° C. in air. A SEM micrograph of the film is set forth in FIG. 3.

The resulting composite showed significant improvements in current voltage, breakdown strength, leakage current density and loss tangent. For instance, the presence of the buffer layer in the composite of the invention reduces statistical average of leakage current density and narrows distribution of leakage current density due to more uniformity.

Improvements may be noted in FIG. 4 which plots the leakage current density of the BaO_{0.5} SrO_{0.5} TiO₃ thin film capacitor on the nickel-coated copper foil. The dash line shows the density-voltage curve of a BaO_{0.}₅ SrO_{0.5} TiO₃ thin film without the buffer layer. The total thickness of both films is about 550 nm and the electrode area is 7.8×10⁻³ cm².

What is claimed is:

1. A method of making a multi-layer, thin film composite which comprises:
(A.) depositing onto a substrate a precursor composition for a buffer layer, the composition comprising an organic solvent, a polymeric heterocyclic amide and organic metallic compounds;
(B.) heating the product of step (A.) to render a composite of a buffer layer and substrate;
(C.) depositing onto the product of step (B.) a precursor composition for a dielectric thin film layer comprising an organic solvent and organometallic compound;
(D.) heating the product of step (C.) to render a composite wherein the buffer layer is between the substrate and the dielectric thin film layer; and
(E.) annealing the product of step (D.).

2. The method of claim 1, wherein the polymeric heterocyclic amide is polyvinyl pyrrolidone.

3. The method of claim 1, further comprising annealing the product of step (D.) at a temperature between from about 550° C. to about 750° C.

4. The method of claim 1, wherein the buffer layer of step (B.) has a thickness of between about 20 to about 300 nm.

5. The method of claim 4, wherein the dielectric thin film layer has a thickness between from about 50 to about 900 nm.

6. The method of claim 5, wherein the thickness of the dielectric layer is greater than the thickness of the buffer layer.

7. The method of claim 6, wherein steps (C) and (D) are repeated such that the dielectric thin film layer comprises a multitude of layers.

8. The method of claim 2, wherein the buffer layer and the dielectric thin film layer contain some of the same elements.

9. The method of claim 2, wherein the buffer layer and/or the dielectric thin film layer is selected from the group consisting of a lead lanthanide titanate, lead titanate, lead zirconate, lead magnesium niobate, barium titanate, lead zirconate titanate, barium strontium titanate, lanthanum-modified lead zirconate titanate, bismuth zinc niobate and bismuth strontium tantalite.

10. The method of claim 9, wherein the dielectric thin film layer comprises lead zirconate titanate, barium strontium titanate, lanthanum-modified lead zirconate titanate, bismuth zinc niobate and/or bismuth strontium tantalite.

11. The method of claim 9, wherein the buffer layer and/or the dielectric thin film layer is of the formula (Ba₁₋ₓSrₓ)TiO₃, PbZr₁₋ₓTiₓO₃ or Pb_{y}La_{z}(Zr₁₋ₓTiₓ)O₃ wherein x is between from about 0.1 to about 0.9, y is from about 0.95 to about 1.25 and z is between from about 0 to about 0.15.

12. The method of claim 11, wherein x is between from about 0.30 to about 0.70.

13. The method of claim 9, wherein the buffer layer and/or dielectric thin film layer is of the formula Bi₃ₓZn₂₍₁₋ₓ₎Nb₂₋ₓO₇ wherein x is between from about 0.40 to about 0.75.

14. The method of claim 9, wherein the buffer layer and/or the dielectric thin film layer is of the formula SrₓBi_{y}Ta₂O_{5+x+3y/2} wherein x is between from about 0.50 to about 1.0 and y is between from about 1.9 to about 2.5.

15. The method of claim 1, wherein the substrate is selected from the group consisting of a semiconductor, glass or a metallic foil.

16. The method of claim 15, wherein the semiconductor contains a Group 3-4 or 13-14 metal and the metallic foil is selected from the group consisting of aluminum, brass, nickel alloy, nickel-coated copper, platinum, titanium and stainless steel foil.

17. The method of claim 7, wherein the dielectric thin film layer is composed of several dielectric layers in a regular or irregular superlattice structure, the elements in each dielectric layer being the same.

18. A ferroelectric multi-layer thin film composite comprising a metallic substrate and at least one crystalline layer prepared by the process of claim 1.

19. A method of making a multi-layer ferroelectric thin film composite which comprises:
(A.) depositing onto a substrate a precursor composition for a buffer layer containing polyvinylpyrrolidone, and heating until forming a buffer layer having a thickness between from about 20 to about 300 nm;
(B.) depositing onto the buffer layer a second precursor composition for a dielectric thin film layer and heating until a thin film layer having a thickness of from about 50 to about 900 nm is formed, the thickness of the dielectric thin film layer being greater than the thickness of the buffer layer; and
(C.) annealing the product of step (B.) at a temperature between from about 550° C. to about 750° C.
further wherein the precursor composition for the buffer layer is deposited by sol-gel and contains polyvinylpyrrolidone.

20. A ferroelectric thin film capacitor, memory device, pyroelectric sensor device, wave guide modulator or acoustic sensor containing the multi-layer thin film composite of claim 19.
